(19) United States
(12) Patent Application Publication
(10) Pub. No.: US 2012/0092863 A1
(43) Pub. Date: Apr. 19, 2012

(54) PATTERN-PROJECTING LIGHT-OUTPUT SYSTEM

(75) Inventors: Marcellinus Petrus Carolus Michael Krijn, Eindhoven (NL); Michel Cornelis Josephus Marie Vissenberg, Eindhoven (NL); Tim Dekker, Eindhoven (NL)

(73) Assignee: KONINKLIJKE PHILIPS ELECTRONICS N.V., Eindhoven (NL)

(21) Appl. No.: 13/256,235

(22) PCT Filed: Mar. 11, 2010
(86) PCT No.: PCT/IB2010/051047

§ 371 Date: Dec. 28, 2011

(30) Foreign Application Priority Data
Mar. 13, 2009 (EP) 09155156.4

(51) Int. Cl. F21V 14/00; F21V 5/04

(52) U.S. Cl. 362/231; 362/235

(57) ABSTRACT

A light-output system (1), for forming a controllable pattern (10) of illuminated spots (11a-b) in a distant projection plane (3). The light-output system (1) comprises a plurality of individually controllable light-output devices (6a-c) arranged in an array (5) of light-output devices with a light-output device pitch (P_{LS}), and an optical system (7) arranged between the array (5) of light-output devices and the projection plane (3). The optical system (1) is configured to project light emitted by the array (5) of light-output devices in the projection plane (5) as a projected array of illuminated spots (11a-c) having a projection pitch (Pₛₚₒₜ) that is larger than the light-output device pitch (P_{LS}). Using this light-output system, practically all of the luminous power output by the light-output devices is used for projecting the light patterns.

### FIELD OF THE INVENTION

The present invention relates to a light-output system for forming a controllable pattern of illuminated spots in a distant projection plane.

### BACKGROUND OF THE INVENTION

With the ongoing progress in the development of new light-sources, such as new and improved light-emitting diodes (LEDs), new areas of applications have emerged. For example, products have been developed that enable a user to create atmospheres using controllable lighting. One example of such a product is the LivingColours lamp from Philips which, through its intuitive remote control, gives the user the freedom to discover an infinite range of colors.

As a further step, it would be desirable to enable the user to control further aspects of lighting, such as forming controllable light patterns on a wall or similar.

Existing devices, such as electronic projectors, can be used to form such controllable patterns. However, only a small fraction of the light generated by the light-source in such devices—typically as small a fraction as 5%—is in fact used for creating the pattern.

### SUMMARY OF THE INVENTION

In view of the above-mentioned and other drawbacks of the prior art, a general object of the present invention is to provide an improved light-output system enabling the formation of controllable light patterns on a wall or similar with a higher luminous efficiency than existing electronic projection devices.

Accordingly, the invention provides a light-output system, for forming a controllable pattern of illuminated spots in a distant projection plane, the light-output system comprising: a plurality of individually controllable light-output devices arranged in an array of light-output devices with a light-output device pitch; and an optical system arranged between the array of light-output devices and the projection plane, the optical system being configured to project light emitted by the array of light-output devices in the projection plane as a projected array of illuminated spots with a one-to-one relation to the light-output devices, the projected array having a projection pitch being larger than the light-output device pitch.

The term “light-output device” should, in the context of the present application, be understood to refer to any device capable of outputting light, that is, electromagnetic radiation within the visible spectrum.

The “pitch” of an array refers to the distance between adjacent devices comprised in the array in one of the principal directions of the array. As is understood by the person skilled in the art, a one-dimensional array has one pitch value and a two-dimensional array has two pitch values, which may or may not be equal.

The present invention is based on the realization that controllable light patterns can be projected on a wall or similar with a very high luminous efficiency by generating the pattern to be projected using an array of light-output devices and projecting the individual light-output devices to corresponding spots on the wall or similar, the pitch of the array of spots being larger than the pitch of the array of light-output devices.

The projected array of illuminated spots may advantageously comprise the same number of array elements as the array of light-output devices.

Using the light-output system according to the present invention, practically all of the luminous power output by the light-output devices is used for projecting the light patterns. This results in a dramatically improved luminous efficiency of the light-output system as compared to prior art systems relying upon light being modulated by a spatial light modulator or similar.

Furthermore, the optical system according to the invention can be made very compact and cost-efficient, since only an array of light-output devices and an optical system without moving parts and/or individually controllable elements are needed to achieve the desired controllable patterns of projected light.

The optical system arranged between the array of light-output devices and the projection plane may advantageously comprise an array of optical elements having an optical element pitch.

Moreover, the optical elements may be focusing lenses. The focusing lenses may advantageously have substantially identical focusing properties.

According to one embodiment, the optical element pitch of the array of optical elements may be larger than the light-output device pitch and smaller than the projection pitch. With such a configuration, the projected array of illuminated spots having a projection pitch being larger than the light-output device pitch can be achieved without the aid of any additional optical arrangements.

Since the distance between the projection surface and the optical elements is typically considerably larger than the distance between the light-output devices and the optical elements, the optical element pitch may advantageously be larger than the light-output device pitch by a factor ranging between 1 and 1.25, and more advantageously by a factor ranging between 1.05 and 1.18. In other words, the optical element pitch may be related to the light-output device pitch according to the following relation:

P_{optical element}=αP_{light-output device},

where P_{optical element} is the optical element pitch; P_{light-output device} is the light-output device pitch, and α is the above-mentioned factor.

To ensure that the light output by each of the light-output devices in the array of light-output devices is projected by its associated optical element in the optical element array, the number of optical elements in the optical element array may advantageously fulfill the following relation:

N(P_{optical element}−P_{light-output device})<P_{optical element},

where:

N is the largest dimension of the optical element array in any direction;

P_{optical element} is the optical element pitch; and

P_{light-output device} is the light-output device pitch.

Furthermore, each light-output device may comprise at least a first light-source and a second light-source configured to emit differently colored light. This enables projection of colored patterns.

Advantageously, a first light-source comprised in a first light-output device may be arranged in relation to the optical element associated with the first light-output device in such a way that light emitted by the first light-source is projected as a spot associated with a second light-source comprised in a second light-output device. The second light-output device may be located adjacent to the first light-output device, or the first and second light-output devices may be spaced apart by one or several other light-output devices.

This light-output device configuration enables controlling the color of a projected spot through mixing of light output by light-sources comprised in different light-output devices.

Moreover, first and second adjacent light-sources comprised in a given light-output device may be spaced apart by a distance Δ_{LS} given by the relation:

$${Δ}_{LS} = n \frac{{z}_{o}}{{z}_{i}} {P}_{Spot} ,$$

where n is an integer 1, 2, 3, . . . , zᵢ is the optical distance between the optical element associated with the light-output device and the projection plane, zₒ is the optical distance between the light-output device and the optical element, and Pₛₚₒₜ is the projection pitch. As is well known to the skilled person, the “optical distance” is the physical distance times the refractive index of the medium through which the light travels.

Hereby, substantially complete overlap between differently colored sub-spots can be achieved, whereby artifacts, such as colored fringes can be avoided.

According to a further embodiment, the optical system may additionally comprise a beam-directing member arranged between the array of optical elements and the projection plane, the beam-directing member being configured to direct light-beams exiting from the array of optical elements towards the projected array of illuminated spots in the projection plane.

With a beam-directing member arranged between the array of optical elements and the projection plane, the difference between the optical element pitch and the output element pitch can be made smaller (the optical element pitch and the output element pitch can even be equal), whereby a larger array of optical elements (light-output devices) can be accommodated, which enables higher resolution and/or the formation of a larger projected pattern at a given distance.

The beam-directing member may comprise an array of directing optical elements, each being configured to direct a light-beam exiting from an associated optical element in the array of optical elements towards an associated spot in the projected array of illuminated spots in the projection plane.

Alternatively or in combination with the above-described beam-directing member being arranged between the array of optical elements and the projection plane, the light-output system according to various embodiments of the invention may comprise a beam-directing member arranged between the array of light-output devices and the array of optical elements. This beam-directing member may comprise an array of directing optical element in analogy with what is described above.

Moreover, the light-output system may advantageously be configured to enable relative movement between the array of light-output devices and the optical system. According to this embodiment, the position one of or both of the array of light-output devices and the optical system may be adjustable. Hereby, the configuration of the projected spots can be adjusted by the user in accordance with the conditions at the location of application of the light-output system.

For example, the light-output system may be configured to enable adjustment of a distance between the array of light-output devices and the optical system. Hereby, the light-output system can be adapted for different distances to the surface onto which the pattern should be projected and/or different desired overlaps between adjacent spots on the surface.

Moreover, the alignment between the array of light-output devices and the optical system may be adjustable, that is, either or both of the array of light-output devices and the optical system may be moveable in a sideways direction, whereby the user can adjust the location of the projected pattern of illuminated spots, while the light-output system remains stationary.

Furthermore, the light-output system may comprise partitioning walls separating the light-output devices, the partitioning walls being arranged between the array of light-output devices and the optical system. Hereby, it can be prevented that the direction of light output by a given light-output device is modified by an optical element which is not associated by that light-output device.

### BRIEF DESCRIPTION OF THE DRAWINGS

These and other aspects of the present invention will now be described in more detail, with reference to the appended drawings showing currently preferred embodiments of the invention, wherein:

FIG. 1 schematically illustrates an exemplary light-output system projecting a light pattern on a wall;

FIG. 2 is a schematic representation of a portion of the light-output system in FIG. 1, illustrating one possible configuration thereof;

FIG. 3 is a section of a simplified representation of the partial light-output system in FIG. 2 along the line A-A′, illustrating the geometry of the light-output system;

FIG. 4 is a section view of the partial light-output system in FIG. 2 along the line A-A′, illustrating how differently colored spots can be formed;

FIG. 5 is a schematic representation of a portion of the light-output system in FIG. 1, illustrating another possible configuration thereof;

FIG. 6 is a schematic representation of a portion of the light-output system in FIG. 1, illustrating yet another possible configuration thereof, including a beam-directing member being arranged between the optical element array and the projection plane; and

FIG. 7 is a section view of the partial light-output system in FIG. 6 along the line B-B′.

### DESCRIPTION OF A PREFERRED EMBODIMENT OF THE PRESENT INVENTION

In the following description, the present invention is mainly described with reference to a light-output system, in which the light-output devices comprise a plurality of differently colored light-emitting diodes (LEDs), and an array of conventional positive lenses.

It should be noted that this by no means limits the scope of the invention, which is equally applicable to light-output systems comprising other types of light-output devices, as well as other optical elements, such as fresnel lenses etc.

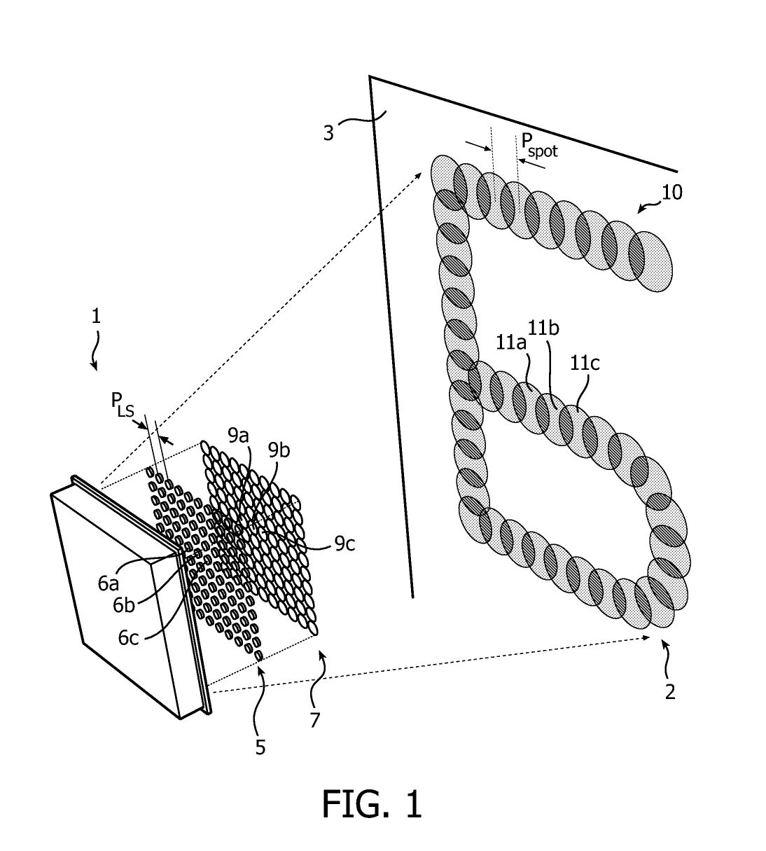

FIG. 1 is an exploded view, schematically illustrating an exemplary light-output system 1 projecting a pattern 2 on a distant wall 3 representing a projection plane. Referring to FIG. 1, the light-output system 1 comprises an array 5 of individually controllable light-output devices 6a-c (only three of these are indicated using reference numerals to avoid cluttering the drawing) and an optical system 7 comprising an array of optical elements 9a-c arranged between the light-output devices 6a-c and the projection plane 3.

Furthermore, as is schematically illustrated in FIG. 1, light output by the array 5 of light-output devices 6a-c is projected as a projected array 10 of illuminated spots 11a-c. The pitch (distance between neighboring light-output devices) P_{LS} of the array 5 of light-output devices 6a-c is, as can be seen in FIG. 1, considerably smaller than the pitch Pₛₚₒₜ of the illuminated spots 11a-c in the projection plane 3. The translation from the light-output device pitch P_{LS} to the pitch Pₛₚₒₜ of the illuminated spots 11a-c is taken care of by the optical system 7 arranged between the array 5 of light-output devices 6a-c and the projection plane 3, and will be further described below with reference to a number of illustrative embodiments of the light-output system in FIG. 1.

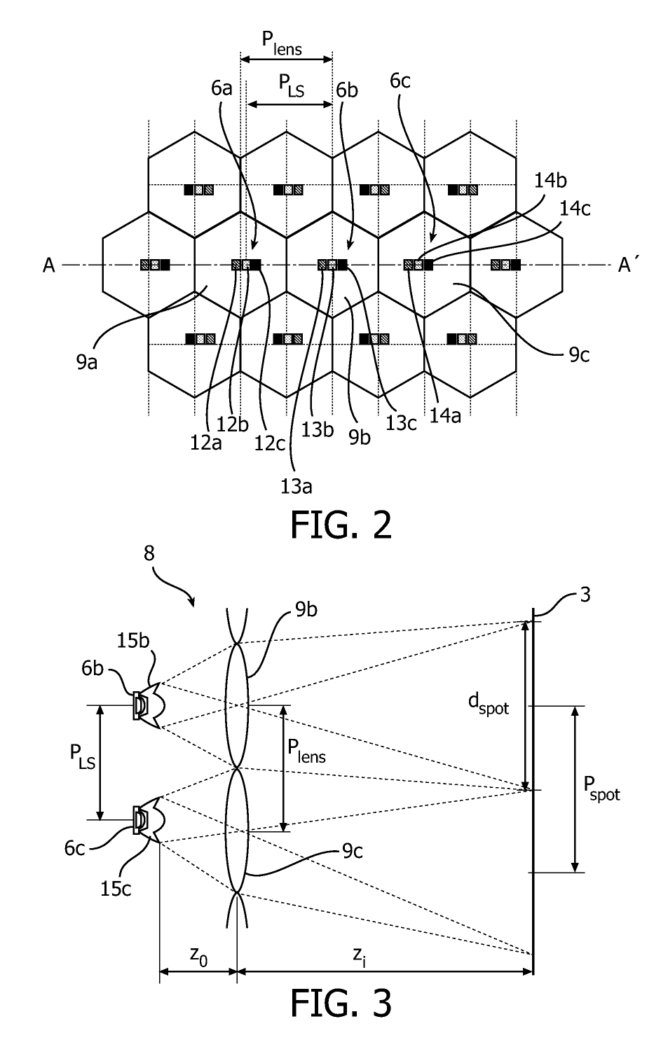

A first embodiment of the light-output system having the basic configuration illustrated in FIG. 1 will now be described with reference to FIG. 2.

FIG. 2 is a plane view of the light-output system 1 seen from the projection plane 3 in FIG. 1, and light-output devices 6a-c are visible through the optical elements 9a-c. In this particular embodiment, each light-output device 6a-c comprises a blue LED 12a, 13a, 14a, a red LED 12b, 13b, 14b, and a green LED 12c, 13c, 14c, and the optical elements 9a-c are provided in the form of lenses arranged with a pitch P-lens which is larger than the light-output device pitch P_{LS}. Although, the embodiment illustrated in FIG. 2 is a color controllable embodiment, the principle of the translation from the light-output device pitch P_{LS} to the pitch Pₛₚₒₜ of the illuminated spots 11a-c in FIG. 1 will first be described with reference to a simplified monochrome case which is schematically illustrated in FIG. 3, and which corresponds to the configuration of FIG. 2 with the red LEDs 12b, 13b, 14b only.

With reference to FIG. 3, the relations between the geometric properties of the present embodiment of the light-output system 1 will now be described. In the embodiment schematically illustrated in FIG. 3, the optical elements 9b-c are arranged at an optical distance zₒ from the light-sources 6b-c, and the projection plane 3 is located at an optical distance z, from the optical elements 9b-c. As is indicated in FIG. 3, each light-source 6b-c may be equipped with collimating optics 15b-c to collimate the light emitted by the light-sources 6b-c somewhat. This is done to ensure that most of the light emitted by the light-sources 6b-c can be captured by the corresponding lens 9b-c.

Now, in the embodiment that is schematically illustrated in FIG. 3, the translation from the light-source pitch P_{LS} to the pitch Pₛₚₒₜ of the illuminated spots in the projection plane 3 is achieved by suitably selecting the geometry of the system, that is, for a given light-source pitch P_{LS}, suitably selecting the distance zₒ between the light-sources 6b-c and the lenses 9b-c and the pitch Pᵢₑₙₛ of the lenses 9b-c in the lens array 8.

In particular, the configuration of the optical system according to the presently illustrated embodiment should fulfill the following relation:

$${P}_{LS} = {P}_{Lens} - \frac{{z}_{o}}{{z}_{i}} ( {P}_{Spot} - {P}_{Lens} ) . \qquad ( 1 )$$

Since in practice P_{Spot}>>P_{Lens}, equation (1) implies that P_{LS} is smaller than P_{Lens}. Preferably, 0.8 P_{Lens Lens}<P_{LS}<P_{Lens}. Even more preferred is 0.85 P_{Lens Lens}<P_{LS}<0.95 P_{Lens}. Note also that zₒ<<zᵢ.

The size of the spots projected on the wall, dₛₚₒₜ, is typically equal to the magnification factor of the system times the dimension of the light-source 6a-b (plus the collimator 15b-c if applicable), d_{LS}:

$${d}_{Spot} = \frac{{z}_{i}}{{z}_{o}} {d}_{LS} . \qquad ( 2 )$$

To ensure smooth transitions in intensity and color in the pattern 2 (FIG. 1) being projected in the projection plane 3, a certain overlap between neighboring dots 11a-c (FIG. 1) is desirable. This overlap follows from the relation:

$$O = \frac{{d}_{Spot} - {P}_{Spot}}{{d}_{Spot}} \times 100 \% . \qquad ( 3 )$$

It has been found that an overlap O>25% gives the desired smooth transitions. Furthermore, to maintain the ability to discern neighboring dots 11a-c, (prevent loss of resolution of the light pattern 2 projected onto the wall 3) the overlap may have an upper limit, which may advantageously be O<75%.

It should be noted that extra overlap can be created by locating a further optical element (not shown in FIG. 3), such as a diffuser (or an array of weak and fine-pitched lenses) close to the plane of the lenses.

Having now explained the geometry of one exemplary embodiment of the light-output system 1 whereby the desired translation between the pitch P_{LS} of the light-output devices 6a-c and the pitch Pₛₚₒₜ of the spots 11a-c projected in the projection plane 3 can be achieved, we will now move on to describe how the configuration of FIG. 3 can be modified to enable the formation of colored projected patterns.

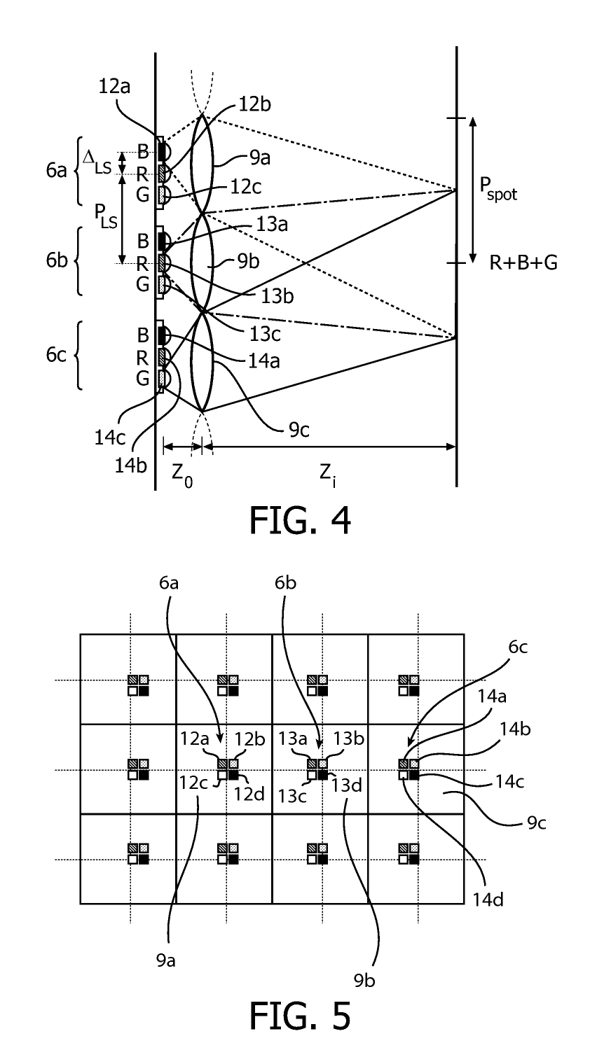

FIG. 4 is a section view of the partial light-output system in FIG. 2 along the line A-A′, illustrating how differently colored spots can be formed using the light-output system in FIG. 1.

To achieve a high quality pattern with colored illuminated spots 11a-c, it is desirable to ensure that spots of basic colors are projected in the projection plane 3 in such a way that they substantially fully overlap. In this manner, spots of virtually freely controllable colors can be formed without artifacts such as colored fringes etc.

Referring to FIG. 4, an exemplary embodiment will now be described, in which the system is based on three primary colors, red (=R), green (=G), and blue (=B). Behind (as seen from the projection plane 3) each lens 11a-c, a triplet of RGB-LEDs 12a-c, 13a-c, 14a-c is located. The light emitted by each LED of these triplets results in a spot of light on the wall 3, as is schematically illustrated in FIG. 4 for the blue LED 12a, the red LED 13b, and the green LED 14c. The resulting spot 11b will appear white.

To ensure that the illuminated spots resulting from different light-sources comprised in different light-output devices 6a-c (here LED-triplets) overlap, a suitable spacing between the light-sources comprised in the light-output devices 6a-c should be selected.

Referring to the exemplary embodiment in FIG. 4, it can be ensured that each LED of a certain color results in a spot of light on the wall that fully overlaps with the light of a LED of a complementary color of a another triplet by arranging the LEDs 12a-c, 13a-c, 14a-c within each triplet 6a-c with a suitable spacing. This spacing distance follows from the relation:

$${Δ}_{LS} = n \frac{{z}_{o}}{{z}_{i}} {P}_{Spot} . \qquad ( 4 )$$

In this relation, n is an integer indicating the distance, in units of the spot pitch Pₛₚₒₜ, between spots resulting from projection of light output by neighboring light-sources in a light-output device 6a-c. Advantageously, the spacing distance Δ_{LS} may be selected such that n=1 in the above relation. In case one is not able to position differently colored light-sources that close together, one can opt for n=2 or n=3.

It should be note that the differently colored light-sources 12a-c, 13a-c, 14a-c may be provided as separate devices or may be packaged together in one and the same housing.

As an alternative to the hexagonal arrangement of the light-output devices illustrated in FIG. 2, the light-output devices 6a-c may be arranged in a rectangular configuration, as is schematically illustrated in FIG. 5.

The configuration in FIG. 5 also differs from that described above with reference to FIG. 2 in that each light-output device 6a-c comprises four light-sources 12a-d, 13a-d, 14a-d, where the fourth light-source is a light-source configured to emit white light to achieve improved illumination.

It should be noted that, just as was the case for the embodiment illustrated in FIG. 2, the pitch of the optical elements 9a-c is larger than the pitch of the light-output devices 6a-c in both the horizontal and the vertical direction.

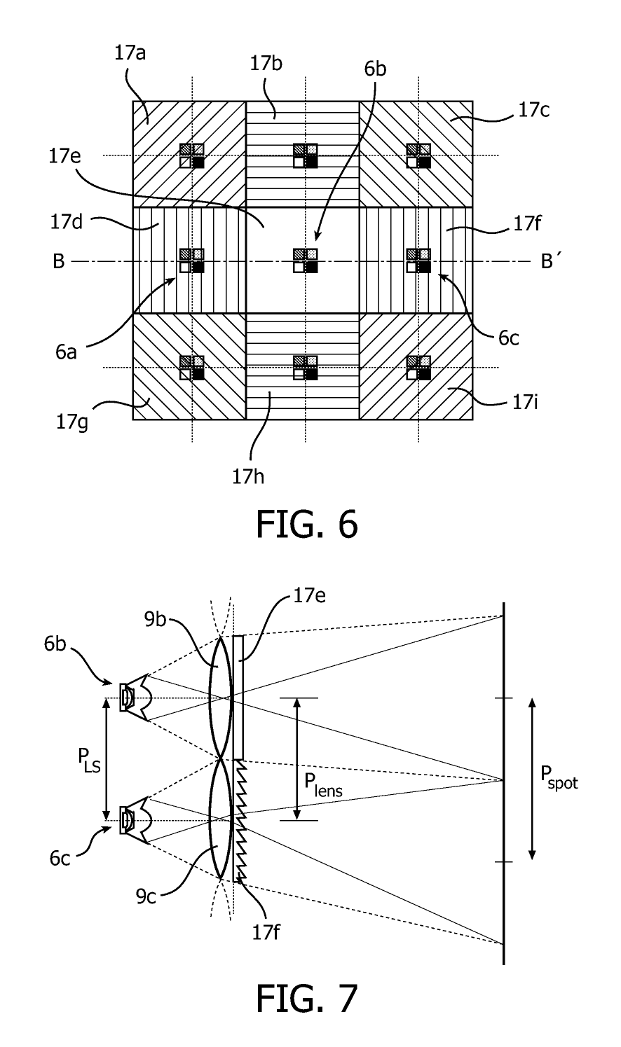

Next, with reference to FIGS. 6 and 7, we will discuss yet another possible configuration useable in various embodiments of the light-output system 1 in FIG. 1.

According to the various configurations discussed so far, the translation from the light-output device pitch P_{LS} to the pitch Pₛₚₒₜ of the illuminated spots 11a-c projected in the projection plane 3 has been achieved by selecting a suitable pitch Pₗₑₙₛ of an array of lenses arranged between the array 5 of light-output devices 6a-c and the projection plane 3.

As an alternative or complement, the light-output system 1 may be provided with a beam-directing member arranged between the array of optical elements 9a-c and the projection plane 3 to direct the light beams having passed through the optical elements 9a-c to achieve illuminated spots 11a-c with the desired pitch Pₛₚₒₜ in the projection plane 3.

For example, as is schematically illustrated in FIG. 6, the pitch Pₗₑₙₛ of the optical elements 9a-c can be selected to be the same as the pitch P_{LS} of the light-output devices 6a-c, and a beam-directing member be arranged between the optical elements 9a-c and the projection plane 3 to achieve substantially all of the translation from P_{LS} to Pₛₚₒₜ.

It will be appreciated by the skilled person that the magnitude and direction of the beam deflection brought about by the beam-directing member will depend on the location in the array, and that the beam-directing member should, in the case illustrated in FIG. 6, be configured in such a way that, when tracing back the rays from the outside of the light-output system 1 through the beam-directing member and the array of optical elements 9a-c towards the light-output devices 6a-c, the light-output devices 6a-c appear to be spaced at a pitch P_{LS} given by equation (1).

An example of a simple beam-directing member schematically illustrated in the exemplary configuration of FIG. 6 is based on a fine-pitched one-dimensional array of prisms 17a-i. The beam-directing member may comprise a plurality of optical elements, or may be provided as one large overall beam-directing member, which may, for example, be a large negative lens, preferably a Fresnel-type lens.

In FIG. 7, which is a section view of the partial light-output system in FIG. 6 along the line B-B′, the principle of post-deflection is schematically illustrated for the simplified case with monochrome light-output devices 6a-b. Through the configuration in FIG. 7, the same spot pitch Pₛₚₒₜ is achieved for the same optical element pitch Pₗₑₙₛ as in FIG. 3.

Finally, it should be noted that various measures may be taken to avoid boundary effects in color controllable embodiments of the light-output system 1 according to the present invention. According to one approach, the light-sources close to the edges of the array 5 of light-output devices, which cannot be complemented with the other colors needed to provide the full spectrum of colors for that spot location on the wall may be controlled not to emit light, or may be omitted from the light-output system 1.

The person skilled in the art will realize that the present invention is by no means limited to the preferred embodiments. For example, partitioning walls (absorbing) may be placed between neighboring light-output devices 6a-c, to ensure that the light emitting by a particular light-output device can only travel through the corresponding lens and not through a neighboring lens. Moreover, in case one wants to project a pattern on the wall from an oblique angle, it may be advantageous to have a smaller than average distance between the light-output devices and the optical elements for the spots projected close to the light-output system and have a larger than average distance between the light-output devices and the optical elements for the spots projected further from the light-output system. Furthermore, Fresnel-type lenses, being strong (high magnifying power) yet light-weight lenses, may advantageously be used as the optical elements. Additionally, some or all of the optical elements comprised in the light-output system may advantageously be electrically adjustable active optical elements based on for example liquid-crystals or electro-wetting. For example, by using an active diffuser, one can tune the overlap of the spots of light on the wall. By using an active post-deflector one is able to tune the size of the pattern of spots of light on the wall.

1. A light-output system, for forming a controllable pattern of illuminated spots in a distant projection plane, said light-output system comprising:
a plurality of individually controllable light-output devices arranged in an array of light-output devices with a light-output device pitch; and
an optical system arranged between said array of light-output devices and said projection plane,
said optical system being configured to project light emitted by said array of light-output devices in said projection plane as a projected array of illuminated spots having a projection pitch being larger than said light-output device pitch.

2. The light-output system according to claim 1, wherein said optical system comprises an array of optical elements having an optical element pitch.

3. The light-output system according to claim 2, wherein said optical elements are focusing lenses.

4. The light-output system according to claim 2, wherein said optical element pitch is larger than said light-output device pitch and smaller than said projection pitch.

5. The light-output system according to claim 4, wherein said optical element pitch is larger than said light-output device pitch by a factor ranging between 1 and 1.25.

6. (canceled)

7. The light-output system according to claim 2 wherein each light-output device comprises at least a first light-source and a second light-source configured to emit differently colored light.

8. The light-output system according to claim 7, wherein a first light-source comprised in a first light-output device is arranged in relation to the optical element associated with said first light-output device in such a way that light emitted by said first light-source is projected as a spot associated with a second light-source comprised in a second light-output device.

9. The light-output system according to claim 8, wherein first and second adjacent light-sources comprised in a given light-output device are spaced apart by a distance Δ_{LS} given by the relation:
$${Δ}_{LS} = n \frac{{z}_{o}}{{z}_{i}} {P}_{Spot} ,$$
where n is an integer 1, 2, 3, . . . , zᵢ is the optical distance between said optical element associated with said light-output device and said projection plane, zₒ is the optical distance between said light-output device and said optical element, and Pₛₚₒₜ is said projection pitch.

10. The light-output system according to claim 2, wherein said optical system further comprises a beam-directing member arranged between said array of optical elements and said projection plane, said beam-directing member being configured to direct light-beams exiting from said array of optical elements towards said projected array of illuminated spots in said projection plane.

11. The light-output system according to claim 2 wherein said optical system further comprises a beam-directing member arranged between said array of light-output devices and said array of optical elements, said beam-directing member being configured to direct light-beams emitted by said light-output devices towards said projected array of illuminated spots in said projection plane.

12. The light-output system according to claim 10, wherein said beam-directing member comprises an array of directing optical elements, each being configured to direct a light-beam emitted by an associated light-output device in said array of light-output devices towards an associated spot in said projected array of illuminated spots in said projection plane.

13. The light-output system according to claim 1, configured to enable relative movement between said array of light-output devices and said optical system.

14. The light-output system according to claim 13, configured to enable adjustment of a distance between said array of light-output devices and said optical system.

15. The light-output system according to claim 2, comprising partitioning walls separating said light-output devices, said partitioning walls being arranged between said array of light-output devices and said optical system.
